(19) United States
(12) Patent Application Publication
(10) Pub. No.: US 2015/0012291 A1
(43) Pub. Date: Jan. 8, 2015

(54) METHOD AND SYSTEM FOR ORDERING SELF-CARE BEHAVIORS

(71) Applicant: KONINKLIJKE PHILIPS N.V., EINDHOVEN (NL)

(72) Inventors: Wilhelmus Johannes Joseph Stut, Eindhoven (NL); Mariana Nikolova-Simons, Bolton, MA (US); Rony Calo, Utrecht (NL)

(21) Appl. No.: 14/368,670

(22) PCT Filed: Dec. 19, 2012
(86) PCT No.: PCT/IB2012/057452

§ 371 Date: Jun. 25, 2014

Related U.S. Application Data
(60) Provisional application No. 61/580,511, filed on Dec. 27, 2011.

(51) Int. Cl. G06F 19/00

(52) U.S. Cl. CPC G06F 19/3431; G06F 19/3443
USPC 705/2

(57) ABSTRACT

The exemplary embodiments are related to systems and methods for ordering self-care behaviors according to an exemplary embodiment described herein. One embodiment relates to a method comprising receiving a desired outcome for a patient having a condition; retrieving information relating to a plurality of self-care behaviors; generating, from the information and the desired outcome, a population-specific ordered list of the self-care behaviors; receiving a self-care behavior assessment for the patient; and generating, from the self-care behavior assessment and the population-specific ordered list, a patient-specific ordered list of the self-care behaviors.

Patients suffering from chronic health conditions are typically instructed to adopt or change various self-care behaviors in order to improve clinical outcomes, such as reducing the chance of hospital admissions, improving health and quality of life, and reducing mortality. There may be a variety of self-care behaviors that correspond to any given condition. In order to improve the likelihood of compliance, a patient may be provided with instructions relating to a limited subset of the self-care behaviors relating to the patient's condition, rather than all such behaviors. However, due to the large amount of data that may be considered, it can be a time-consuming task for medical professionals to determine the appropriate subset for a given patient.

The present invention relates to a method and system for ordering self-care behaviors. The method including receiving a desired outcome for a patient having a condition; retrieving information relating to a plurality of self-care behaviors; generating, from the information and the desired outcome, a population-specific ordered list of the self-care behaviors; receiving a self-care behavior assessment for the patient; and generating, from the self-care behavior assessment and the population-specific ordered list, a patient-specific ordered list of the self-care behaviors.

The system according to an exemplary embodiment of the present invention comprises a processor; a memory; an extraction module receiving a desired outcome for a patient having a condition, retrieving information relating to a plurality of self-care behaviors, the information including an effect of each of the self-care behaviors on the condition and the desired outcome, and generating, from the information, a population-specific ordered list of the self-care behaviors; and a combination module receiving a self-care behavior assessment for the patient and generating, from the self-care behavior assessment and the population-specific ordered list, a patient-specific ordered list of the self-care behaviors.

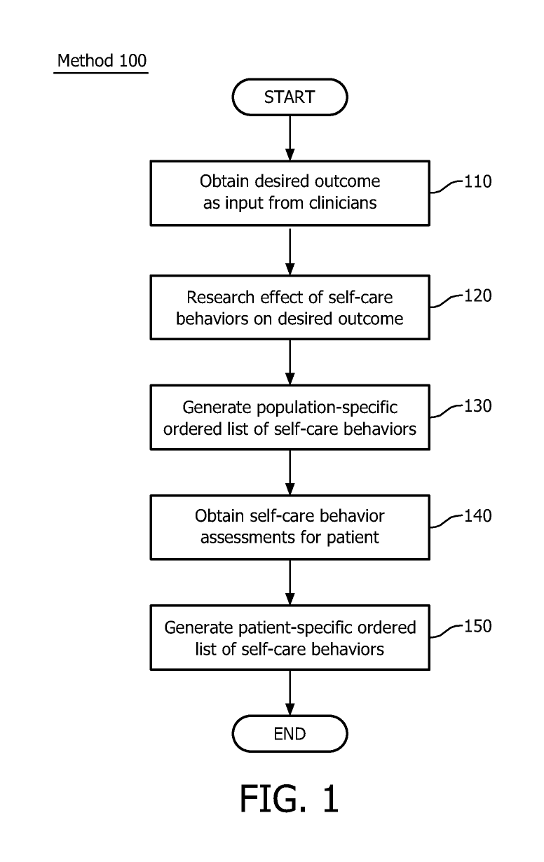

FIG. 1 shows an exemplary method for prioritizing a patient's self-care behaviors according to an exemplary embodiment.

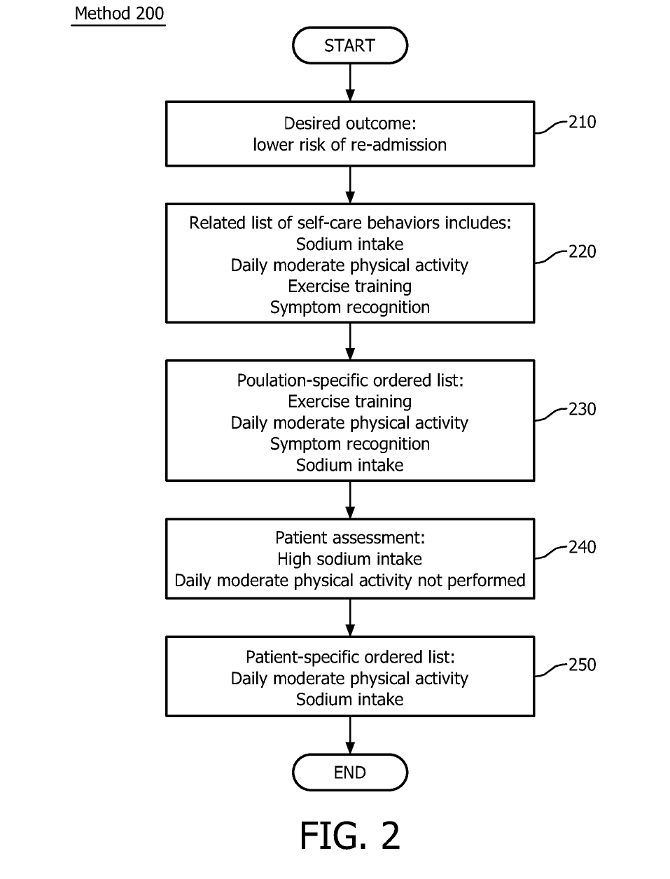

FIG. 2 shows an exemplary application of the exemplary method of FIG. 1 to a sample patient.

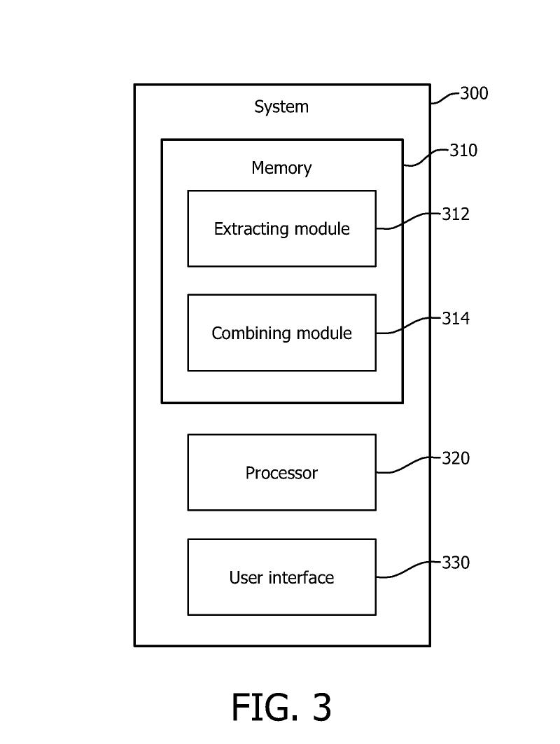

FIG. 3 shows a schematic view of an exemplary system for implementing a method such as the method of FIG. 1 for prioritizing a patient's self-care behaviors according to an exemplary embodiment.

The exemplary embodiments of the present invention may be further understood with reference to the following description of exemplary embodiments and the related appended drawings, wherein like elements are provided with the same reference numerals. Specifically, the exemplary embodiments relate to methods and systems for prioritizing a chronically ill patient's self-care behaviors.

Health care professionals typically recommend that patients who are suffering from chronic conditions should change or adopt multiple health-related self-care behaviors. Examples of such self-care behaviors may include taking medication according to a schedule, performing physical activity, adhering to dietary restrictions such as a low-sodium diet, restricting intake of fluids, restricting tobacco usage, and recognition of symptoms. These recommendations are made in order to improve clinical outcomes, such as reducing the chance of hospital admissions/readmissions, improvement of patient health and quality life, reducing the chance of mortality, etc.

For a given patient or group of patients, a given recommended self-care behavior may have a relative importance depending on the level of effect of the behavior on the resulting clinical outcomes. In the course of instructing a patient on self-care behaviors, a health care professional may place higher emphasis on some behaviors than others based on the relative levels of importance of the behaviors. Placement of emphasis on the most important behaviors may lead to the patient performing the most important behaviors, and may thereby improve the likelihood of achieving the desired outcome.

Therefore, it may be important for a health care professional to properly select the most important behavior or behaviors for emphasis. For example, a professional treating a heart failure patient and attempting to reduce the patient's chance of readmissions may have to decide whether it is more important to focus on adopting a low-sodium diet or on adherence to a medication schedule. Some health care professional may focus on various behaviors based on their own experience or opinions, and others may allow the patient to determine the order based on personal preference. However, neither of these is necessarily the most efficient way to achieve improved clinical outcomes.

Ideally, a health care professional may review various literature, studies, etc., before making self-care behavior recommendations to a patient. However, the large quantity of such materials may make it practically impossible for a provider to be up-to-date with the newest materials that are available. Alternatively, a health care professional may consult clinical guidelines. Though such guidelines report the level of evidence (“LOE”) and importance of recommended behaviors, the evidence reported there has the following limitations: it is not outcome-specific (e.g., does not differentiate between a goal of reducing the risk of mortality and a goal of improving the patient's quality of life), and, additionally, is not updated with the latest clinical trial results because such guidelines are only updated every few years.

The exemplary embodiments may enable health care professionals to overcome the above difficulties by providing a recommendation that is based on the most current evidence, is tailored to fit specific outcomes, and is tailored to the individual patient's condition. FIG. 1 illustrates an exemplary method 100 for generating such a recommendation. Typically, the method 100 may be implemented by means of a computer program consisting of lines of code, compiled and executed by a system including a memory and a processor. Generally, steps 110-130 of the method 100 will be referred to herein as the “extraction” process, and steps 140-150 will be referred to herein as the “combination” process. In step 110, a desired outcome is provided. The desired outcome may be, for example, reduction of readmission rate, improvement of quality of life, reduction of mortality rate, etc. Typically, this will be provided by a medical professional. The exemplary embodiments discussed herein refer to a single desired outcome, but those of skill in the art will understand that other embodiments may allow for multiple desired outcomes to be provided.

In step 120, various knowledge bases are consulted to determine the effect of various patient self-care behaviors on the desired outcome provided in step 110. The knowledge bases may include clinical guidelines, local hospital standards of clinical practice, professional medical expertise, recent clinical trials, etc. Information obtained in this manner may be ranked by class (e.g., class I, II, III, etc.) and by level of evidence (e.g., A, B, C). Those of skill in the art will understand that the level of evidence denotes the existence and types of studies available supporting the recommendation and expert consensus. For example, evidence level “A” may signify data derived from multiple randomized clinical trials or meta-analyses, evidence level “B” may signify data derived from a single randomized clinical trial or large non-randomized studies, and evidence level “C” may signify a consensus of expert opinions, small studies, retrospective studies or registries. Those of skill in the art will further understand that the class of recommendation indicates the strength of the recommendation based on an objective judgment about the relative merits of the data. For example, class “I” may signify evidence and/or general agreement that a given treatment or procedure is beneficial, useful and effective. Class “II” may signify that there is conflicting evidence and/or a divergence of opinion about the usefulness/efficacy of a given treatment or procedure, wherein subclass “IIa” may indicate that the weight of evidence or opinion is in favor of usefulness/efficacy and subclass “IIb” may indicates that the usefulness/efficacy is less well-established by evidence or opinion. Class “III” may signify that there is evidence or general agreement that the given treatment or procedures is not useful or effective, and in some cases may be harmful.

Those of skill in the art will understand that the list of knowledge bases provided above is only exemplary, and that other knowledge bases may be used in various embodiments. In one embodiment, data from all relevant knowledge bases may be stored and indexed in a knowledge database in order to simplify the reference process. Clinical guidelines may be obtained from organizations such as the American Cardiology College, the American Heart Association, the European Society of Cardiology or the Heart Failure Society of America. Those of skill in the art will understand that these organizations are only exemplary, and are specific to guidelines for treatment of patients with heart conditions, and that other organizations may issue guidelines appropriate for the treatment of patients with other types of conditions.

In step 130, a population-specific ordered list of self-care behaviors is generated. Those of skill in the art will understand that “population-specific” means specific to patients having a given condition. In this context, “population-specific” may refer to a broad population, such as patients with heart failure or diabetes, or a narrower population, such as patients with left ventricular ejection fraction (“LVEF”) <45%. In the ordered list, more important self-care behaviors for the selected outcome are ranked more highly. Typically, the class of recommendation and level of evidence from the different knowledge bases consulted in step 120 may be weighted and used to order the list. The weighting of knowledge bases (e.g., clinical guidelines, local hospital standards of practice, professional medical expertise, recent clinical trials, etc.) may be accomplished by indicating in advance which knowledge bases are the most important, and weighting such knowledge bases accordingly. For example, if knowledge bases are ranked in advance as:
1. Clinical guidelines
2. Recent clinical trials
3. Hospital standards of clinical practice
4. Professional medical expertise

Then weighting may be assigned as clinical guidelines: 40%; recent clinical trials: 30%; hospital standards of clinical practice: 20%; professional medical expertise: 10%. Subsequently, in determining the importance of a given self-care behavior, to calculate the importance score for the self-care behavior, evidence from clinical guidelines is weighted at 40% of the importance score for the behavior, evidence from recent clinical trials are weighed at 30% of the importance score for the behavior, etc.

In step 140, the patient's self-care behavior assessments are obtained for combination with the population-specific list generated in step 130. The patient's behavior assessments may indicate, for example, the patient's dietary habits, level of physical activity, or any other patient behavior that may have an impact on clinical outcomes. The assessments may be obtained by surveys, by observation by medical professionals, or using any other means known in the art. Last, in step 150, the patient's self-care behavior assessments from step 140 and the population-specific ordered list from step 130 are combined to produce a patient-specific ordered list. This list may then be used to guide the subsequent instruction of the patient in the most important self-care behavior for achieving the desired outcome that was provided in step 110.

FIG. 2 illustrates an exemplary method 200 illustrating a sample application of the method 100. In step 210, a desired outcome to reduce the patient's risk of readmission is provided. In step 220, knowledge bases (e.g., a database maintained for this purpose) are consulted for information relating to self-care behaviors that may impact the patient's clinical goals. The results of this step may be as shown below:

| | ESC Clinical | |
|---|---|---|
| Self-care behavior | Guideline | Recent Clinical Trial Findings |
| Sodium intake | Class II | — |
| | LOE = C | |
| Daily Moderate Physical | Class I | Physical activity reduces |
| Activity | LOE = B | readmissions |
| Exercise Training | Class I | Exercise training reduces |
| | LOE = A | readmissions |
| Symptom Recognition | Class I | Weight monitoring reduces |
| | LOE = C | readmissions |

In step 230, the information retrieved in step 220, e.g. class of recommendation and level of evidence, is applied to determine a population-specific ordered list of self-care behaviors. This list may be as shown below:
1. Exercise training
2. Daily moderate physical activity
3. Symptom recognition
4. Sodium intake

In step 240, the patient's self-care assessments are obtained. As described above, this may be accomplished, for example, by means of surveys targeted to identify the patient's relevant self-care behaviors. The results of this assessment may be as shown below:
1. Sodium intake above recommended limits
2. Daily moderate physical activity not performed regularly

Finally, in step 250, the patient's self-care assessments from step 240 are combined with the population-specific ordered list of self-care behaviors from step 230 to produce a patient-specific ordered list of self-care behaviors. This list may be as shown below:
1. Daily moderate physical activity
2. Sodium intake

Those of skill in the art will understand that daily moderate physical activity may be ranked ahead of sodium intake on the patient-specific ordered list due to the greater degree of evidence relating to daily moderate physical activity obtained in step 220, and to the resulting higher placement of daily moderate physical activity in the population-specific ordered list generated in step 230. As described above, this list may then be used to guide the subsequent treatment of the patient.

FIG. 3 schematically illustrates an exemplary system 300 for implementing the method 100 of FIG. 1. The system 300 includes a memory 310 storing an extracting module 312 and a combining module 314. The extracting module 312 performs extraction as described above with reference to steps 110-130 of method 100. The combining module 314 performs combination as described above with reference to steps 140-150 of method 100. In one exemplary embodiment, the memory 310 may also store the medical data required to perform steps 120 and 130 of method 100; in another embodiment, the data may be stored remotely, such as in distributed storage.

The system 300 also includes a processor 320 executing the extracting module 312 and the combining module 314. Those of skill in the art will understand that the memory 310 may store other code modules, programs, or other data besides the extracting module 312 and the combining module 314, and that the processor 320 may also execute such programs. Additionally, the system 300 includes a user interface 330 for receiving a selection of a desired outcome, performing patient self-care behavior assessments, providing output lists of self-care behaviors, or any other task known in the art to be performed by a user interface 330.

The exemplary embodiments provide a mechanism by which a population-specific list of self-care behaviors appropriate to a given desired outcome may be determined The exemplary embodiments further enable medical professionals to adapt such a list, in view of a given patient's self-care behaviors, to provide an ordered patient-specific list of self-care behaviors to enable the patient to achieve the desired outcome. The medical professional may then prioritize treatment in view of such an ordered list to maximize the chances of achieving the desired outcome. Those of skill in the art will understand that the exemplary method may be performed by a system that performs other knowledge-based health care tasks in order to provide an integrated health care knowledge base.

It will be apparent to those skilled in the art that various modifications may be made in the present invention, without departing from the spirit or the scope of the invention. Thus, it is intended that the present invention cover modifications and variations of this invention provided they come within the scope of the appended claims and their equivalents.

1. A method, comprising:
receiving a desired outcome for a patient having a condition;
retrieving information relating to a plurality of self-care behaviors;
generating, from the information and the desired outcome, a population-specific ordered list of the self-care behaviors;
receiving a self-care behavior assessment for the patient; and
generating, from the self-care behavior assessment and the population-specific ordered list, a patient-specific ordered list of the self-care behaviors.

2. The method of claim 1, wherein the information retrieved comprises one of clinical guidelines, local hospital standards of clinical practice, and recent clinical trials.

3. The method of claim 1, wherein the population-specific ordered list corresponds to the condition.

4. The method of claim 1, wherein the desired outcome is one of a reduced likelihood of hospital admission, a reduced likelihood of mortality, an improved quality of life, and an improved patient health.

5. The method of claim 1, wherein the information is retrieved from a database.

6. (canceled)

7. (canceled)

8. The method of claim 1, wherein the information includes an effect of each of the self-care behaviors on the condition and the desired outcome.

9. A system, comprising:
a processor;
a memory;
an extraction module receiving a desired outcome for a patient having a condition, retrieving information relating to a plurality of self-care behaviors, the information including an effect of each of the self-care behaviors on the condition and the desired outcome, and generating, from the information, a population-specific ordered list of the self-care behaviors; and
a combination module receiving a self-care behavior assessment for the patient and generating, from the self-care behavior assessment and the population-specific ordered list, a patient-specific ordered list of the self-care behaviors.

10. The system of claim 9, wherein the information retrieved by the extraction module comprises one of clinical guidelines, local hospital standards of clinical practice, and recent clinical trials.

11. The system of claim 9, wherein the population-specific ordered list corresponds to the condition.

12. The system of claim 9, wherein the desired outcome is one of a reduced likelihood of hospital admission, a reduced likelihood of mortality, an improved quality of life, and an improved patient health.

13. The system of claim 9, further comprising:
a database storing the information.

14. (canceled)

15. (canceled)

16. The system of claim 9, wherein the information includes an effect of each of the self-care behaviors on the condition and the desired outcome.

17. A non-transitory computer-readable storage medium storing a set of instructions executable by a processor, the set of instructions being operable to:
receive a desired outcome for a patient having a condition;
retrieve information relating to a plurality of self-care behaviors, the information including an effect of each of the self-care behaviors on the condition and the desired outcome;
generate, from the information, a population-specific ordered list of the self-care behaviors;
receive a self-care behavior assessment for the patient; and
generate, from the self-care behavior assessment and the population-specific ordered list, a patient-specific ordered list of the self-care behaviors.

18. The non-transitory computer-readable storage medium of claim 17, wherein the information is retrieved from a database.

19. (canceled)

20. The non-transitory computer-readable storage medium of claim 18, wherein the population-specific ordered list corresponds to the condition.
